(19) United States
(12) Patent Application Publication
(10) Pub. No.: US 2026/0360170 A1
(43) Pub. Date: Nov. 12, 2026

(54) CAPTION GENERATION APPARATUS, CAPTION GENERATION METHOD, AND NON-TRANSITORY COMPUTER-READABLE MEDIUM

(71) Applicant: Yokogawa Electric Corporation, Tokyo (JP)

(72) Inventors: Kie SHIMAMURA, Tokyo (JP); Yukiyo AKISADA, Tokyo (JP); Kenji OISHI, Tokyo (JP)

(21) Appl. No.: 19/713,648

(22) Filed: Jun. 18, 2026

Related U.S. Application Data
(63) Continuation of application No. PCT/JP2024/038557, filed on Oct. 29, 2024.

(30) Foreign Application Priority Data
Dec. 20, 2023 (JP) 2023-214705

(51) Int. Cl. G06V 20/70

(52) U.S. Cl. CPC G06V 20/70; G06V 2201/07

(57) ABSTRACT

Provided is a caption generation apparatus comprising an image acquisition unit that acquires an image captured in a plant, a word extraction unit that extracts a plurality of words representing features of a target captured in the image, a state information acquisition unit that acquires state information indicating a state of the captured target, and a caption generation unit that generates a caption describing the captured target according to the state information based on the state information and the plurality of words. The state information may include at least any of position information of a target, deterioration information indicating a deterioration state of the target, fluid information indicating a component or a state of a fluid flowing inside a pipe that is the target, or equipment information related to equipment located upstream or downstream of the pipe that is the target.

The contents of the following patent application(s) are incorporated herein by reference:
NO. 2023-214705 filed in JP on Dec. 20, 2023
NO. PCT/JP 2024/038557 filed in WO on Oct. 29, 2024.

### BACKGROUND

### 1. Technical Field

The present invention relates to a caption generation apparatus, a caption generation method, and a non-transitory computer-readable medium.

### 2. Related Art

Patent Document 1 describes that “the video function abnormality determination means 16 has a function of inputting a result of the abnormality determination means 12 that has determined an abnormality, and determining, based on the result, data indicating a plant state input from the input means 11, and video of a plant situation of the ITV camera 19, that there is an abnormality in a functional element obtained by subdividing a plant function” (paragraph 0024). Patent Document 2 describes that “the display 5 displays an alarm display screen using the alarm function when an alarm condition is satisfied. On the alarm display screen, a date and time when an abnormality occurred and a comment explaining abnormality details are displayed” (paragraph 0039). Patent Document 3 describes that “position information specified by GPS is obtained, a current inspection location is displayed to plant staff, image data captured by an installed camera is . . . accumulated and analyzed, a determination is made as to whether or not there is a sign of an abnormality in plant equipment from past equipment states, abnormal cases, and the like, and at the same time, using a preset format and wording, a periodic inspection report is automatically created from the image data” (paragraph 0053). Patent Document 4 describes that “the feature quantity acquisition unit that acquires, as a first feature quantity, information regarding the pipe from an image obtained by capturing, with the camera, a plant instrument equipment to be worked on and pipe present around the plant instrument equipment, and the feature quantity comparison unit that compares the first feature quantity with a second feature quantity regarding the pipe acquired from design data, are provided” (claim 1). Patent Document 5 describes that “the abnormality e-mail creation function 102 is activated when the abnormality monitoring function 101 detects a plant abnormality, and creates an e-mail transmission text by converting into sentences matters to be promptly communicated to the monitoring person, such as a date and time when an abnormality is detected, a corresponding plant equipment name, and abnormality details” (paragraph 0019).

### Related Art Documents

### Patent Documents

Patent Document 1: Japanese Unexamined Patent Application Publication No. 2000-76570
Patent Document 2: Japanese U.S. Pat. No. 6,419,399
Patent Document 3: Japanese U.S. Pat. No. 6,099,989
Patent Document 4: Japanese U.S. Pat. No. 6,826,509
Patent Document 5: Japanese Unexamined Patent Application Publication No. 2003-51895

The above summary of the invention does not enumerate all of the features of the present invention. Also, sub-combinations of these groups of features can also constitute an invention.

### BRIEF DESCRIPTION OF THE DRAWINGS

FIG. 1 is a schematic overview diagram of a caption generation system 5 including a caption generation apparatus 100 according to a first embodiment.

FIG. 2 is a block diagram of the caption generation apparatus 100 according to the first embodiment.

FIG. 3 is a flowchart illustrating a flow of the caption generation method according to the first embodiment.

FIG. 4 is a flowchart illustrating an example of the detailed flow of the caption generation method according to the first embodiment.

FIG. 5 is the diagram for specifically describing a part of the flow of FIG. 4.

FIG. 6 is the diagram for specifically describing a part of the flow of FIG. 4.

FIG. 7 is a block diagram of the caption generation apparatus 200 according to a second embodiment.

FIG. 8 illustrates an example of the computer 2200 in which a plurality of aspects of the present invention may be embodied in whole or in part.

### DESCRIPTION OF EXEMPLARY EMBODIMENTS

Hereinafter, the present invention will be described through embodiments of the invention; however, the following embodiments do not limit the invention according to the claims. In addition, not all combinations of features described in the embodiments are necessarily essential to the invention.

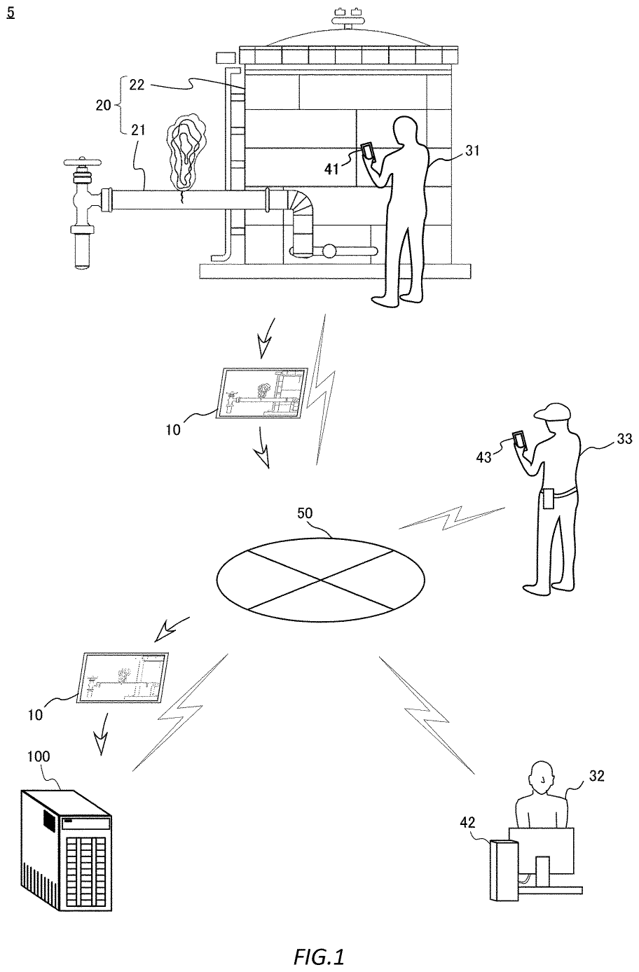

FIG. 1 is a schematic overview diagram of the caption generation system 5 including the caption generation apparatus 100 according to a first embodiment. The caption generation system 5 generates, from an image 10 obtained by capturing the target 20 in a facility in a plant, a caption describing the captured target 20. More specifically, the caption generation system 5 generates a caption describing the captured target 20 in accordance with state information indicating a state of the captured target 20. The image 10 may be one or more still images, or may be a moving image. Note that the caption describing the target 20 in the image 10 may refer to an explanatory sentence describing the state of the target 20 shown in the image 10. The caption as used herein may refer to the sentence delimited by a period, or may refer to a clause delimited more finely than a sentence.

Examples of the plant include, in addition to industrial plants such as chemical plants, plants that manage and control wellheads such as gas fields and oil fields and their surroundings, plants that manage and control power generation such as hydroelectric, thermal, and nuclear power generation, plants that manage and control environmental power generation such as solar power and wind power, and plants that manage and control water supply and sewerage, dams, and the like.

FIG. 1 illustrates, as an example of the target 20 in a facility in a plant, the pipe 21 and the tank 22. As illustrated in FIG. 1, the pipe 21 may have, for example, the upstream side connected to the tank 22, and may cause a liquid or a gas stored in the tank 22 to flow to a downstream side. In FIG. 1, illustration of the instrument equipment on the downstream side of the pipe 21 is omitted.

The caption generation system 5 includes, as an example, the photographer terminal 41 used by the photographer 31, the administrator terminal 42 used by the administrator 32, the worker terminal 43 used by the recovery worker 33, and the caption generation apparatus 100. The photographer terminal 41, the administrator terminal 42, the worker terminal 43, and the caption generation apparatus 100 are communicable with each other via the communication network 50. The communication network 50 may be the wired network, may be the wireless network, or may include both of these.

The photographer terminal 41 captures the image 10 of the target 20. Alternatively or additionally, the imaging device, such as a surveillance camera installed in the plant, or a camera provided in a traveling robot or a drone that patrols within the plant, may capture the image 10 of the target 20. The photographer terminal 41 may be the smartphone with a camera. The photographer terminal 41 may be the tablet terminal. The photographer terminal 41 may be the PC (Personal Computer). The photographer terminal 41 may be the wearable terminal.

The photographer 31 is an example of the user who uses the caption generation system 5, and carries and uses the photographer terminal 41. The photographer 31 captures the image 10 of the target 20 in a facility in the plant by using the photographer terminal 41. The photographer 31 is, as an example, the maintenance worker of instrument in the plant, and more specifically, is the maintenance worker who maintains the tank 22. Note that one photographer 31 may be present in the plant, or a plurality of photographers 31 may be present in the plant.

The administrator terminal 42 displays a report using the caption generated by the caption generation system 5. The administrator terminal 42 transmits an instruction regarding the target 20 in the instrument in the plant to the worker terminal 43 via the communication network 50. The administrator terminal 42 may be the PC, and may be disposed at a location away from the target 20 in a facility in the plant, such as the control room in the plant. Note that the administrator terminal 42 may be the smartphone. The administrator terminal 42 may be the tablet terminal. The administrator terminal 42 may be the wearable terminal.

The administrator 32 is an example of the user who uses the caption generation system 5, and uses the administrator terminal 42. The administrator 32 views, by the administrator terminal 42, a report using the caption generated by the caption generation system 5. The administrator 32, as an example, views the report in a situation in which the administrator 32 cannot directly visually confirm the target 20 described by the caption. The administrator 32 determines the status of the target 20 in a facility in the plant, and instructs the recovery worker 33 or the like to perform recovery work or the like for the target 20. The administrator 32, as an example, determines the status of the pipe 21 in a facility in the plant, and instructs a recovery worker 33 or the like for the pipe 21 to perform recovery work or the like for the pipe 21. Note that one administrator 32 may be present in the plant, or a plurality of administrators 32 may be present in the plant. Note that the administrator 32 is an example of the viewer who views a report using a caption generated by the caption generation system 5.

The worker terminal 43 displays an instruction regarding the target 20 in instrument in the plant, and a report or the like using the caption generated by the caption generation system 5. The worker terminal 43 may be the smartphone. The worker terminal 43 may be the tablet terminal. The worker terminal 43 may be the PC. The worker terminal 43 may be the wearable terminal.

The recovery worker 33 is an example of the user who uses the caption generation system 5, and uses the worker terminal 43. The recovery worker 33, by the worker terminal 43, views instructions regarding the target 20 in instrument in the plant, reports using captions generated by the caption generation system 5, and the like. The recovery worker 33, as an example, views the report in the situation in which the recovery worker 33 cannot directly visually confirm the target 20 described by the caption. The recovery worker 33 deals with an abnormality in the plant. The recovery worker 33, as an example, deals with the abnormality of the pipe 21. The recovery worker 33, as an example, in accordance with instructions and reports from the administrator 32 displayed on the worker terminal 43, recovers the pipe 21 in which the abnormality has occurred. Note that one recovery worker 33 may be present in the plant, or a plurality of recovery workers 33 may be present in the plant. The recovery worker 33 is an example of the viewer who views a report using the caption generated by the caption generation system 5.

The caption generation apparatus 100, as an example, receives, from the photographer terminal 41 via the communication network 50, the image 10 obtained by capturing the target 20 in a facility in the plant. The caption generation apparatus 100 generates, using the image 10 received from the photographer terminal 41, the caption describing the target 20 in the plant in accordance with state information indicating a state of the captured target 20. The caption generation apparatus 100 generates the caption with higher accuracy, that is, outputs an explanatory sentence describing, more accurately, a state of the target 20 and the like, as compared with a case of generating a caption describing the target 20 without using state information from the image 10 obtained by capturing the target 20.

The caption generation apparatus 100 transmits the generated caption to the photographer terminal 41 via the communication network 50. The caption generation apparatus 100 may be disposed in the control room, the instrument room, or the like in the plant, or may be disposed outside the plant. Some functions of the caption generation apparatus 100 may be incorporated in the photographer terminal 41.

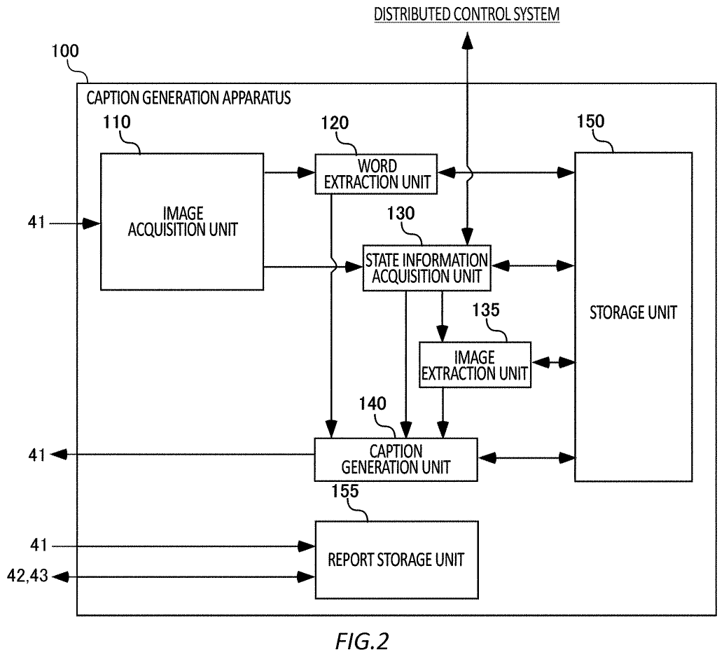

FIG. 2 is a block diagram of the caption generation apparatus 100 according to the first embodiment. In FIG. 2, the flows of data and the like are indicated by arrows. The caption generation apparatus 100 includes the image acquisition unit 110, the word extraction unit 120, the state information acquisition unit 130, the image extraction unit 135, the caption generation unit 140, the storage unit 150, and the report storage unit 155.

The image acquisition unit 110 acquires the image 10 captured in the plant. The image acquisition unit 110, as an example, receives, from the photographer terminal 41 via the communication network 50, together with the image 10 obtained by capturing the target 20 in the plant, a user ID of the photographer 31 who uses the photographer terminal 41. The image acquisition unit 110, as an example, receives, from the photographer terminal 41 via the communication network 50, together with the image 10 obtained by capturing the target 20 in the plant, a user ID of the photographer 31 and imaging information indicating an imaging position and an imaging direction when the photographer terminal 41 captured the image 10 of the target 20. The image acquisition unit 110 inputs the received image 10 to the word extraction unit 120, and also inputs the image 10 to the state information acquisition unit 130 together with the user ID, etc. of the photographer 31.

The word extraction unit 120 extracts the plurality of words representing features of the target 20 captured in the image 10. The word extraction unit 120 may extract one or a plurality of words based on the newly input image 10 by using the word extraction model that has learned a relationship between the image 10 and one or a plurality of words representing features of the target 20 captured in the image 10. The word extraction unit 120 may, for example, read out the word extraction model stored in the storage unit 150. The word extraction unit 120 inputs the plurality of words extracted from the image 10 to the caption generation unit 140, for example, as the vector representation.

The state information acquisition unit 130 acquires state information indicating a state of the target 20 captured in the image 10. The state information acquisition unit 130, as an example, acquires the state information by analyzing the image 10. Specifically, the state information acquisition unit 130 may extract the target 20 from the image 10 by analyzing the image 10, and may determine to which instrument in the plant the target 20 corresponds by collating features of the extracted target 20 with features of a plurality of targets 20 stored in the storage unit 150. The state information acquisition unit 130 may further access the distributed control system, which is outside the caption generation apparatus 100 and controls the plant, and may receive, from the distributed control system, state information regarding instrument corresponding to the target 20. The instrument corresponding to the target 20 may include the instrument itself of the target 20, and may include instrument located upstream or downstream of the target 20. The state information acquisition unit 130 may extract the target 20 from the image 10 by analyzing the image 10, determine to which instrument in the plant the target 20 corresponds, and read out state information regarding the instrument corresponding to the target 20 which is stored in the storage unit 150.

As another example, the state information acquisition unit 130 may acquire state information by acquiring imaging information from the photographer terminal 41. Specifically, the state information acquisition unit 130 may determine to which instrument in the plant the target 20 captured in the image 10 corresponds by collating imaging information from the photographer terminal 41 with a plurality of pieces of imaging information stored in the storage unit 150. The state information acquisition unit 130 may further access the distributed control system, and may receive, from the distributed control system, state information regarding the instrument corresponding to the target 20. The imaging information may additionally indicate a degree of zooming, the distance to the target 20, and the like when the photographer terminal 41 captured the image 10. The state information acquisition unit 130 inputs the acquired state information to the image extraction unit 135, and also inputs the state information, for example, as the vector representation, to the caption generation unit 140 together with the user ID of the photographer 31 and the like.

The state information may include at least any of position information of the target 20, deterioration information indicating a deterioration state of the target 20, fluid information indicating a component or state of a fluid flowing inside a pipe that is the target 20, or equipment information related to equipment located upstream or downstream of the pipe that is the target 20. The state information may include, for example, fixed information such as position information of the pipe 21 and information of the tank 22 upstream of the pipe 21, and may include variable information indicating, for example, the type of gas or liquid flowing inside the pipe 21, the state such as the pressure or the temperature of the gas or liquid, and the degree of deterioration of the pipe 21. The degree of deterioration of the pipe 21 may be the index of a deterioration state according to, for example, a degree of rusting of the pipe 21. As an example, the fixed state information may be stored in the storage unit 150. For example, as the fixed state information, the plant design data indicating a plurality of targets 20 and equipment located upstream or downstream of each target 20 may be stored in the storage unit 150.

When the state information includes position information of the target 20, the image extraction unit 135 extracts, from the storage unit 150, a past image having position information common to the position information included in the new state information, in response to acquiring new state information of the new image 10. The image extraction unit 135 may extract one or a plurality of past images corresponding to the image 10 from the storage unit 150. The image extraction unit 135 inputs the past images extracted from the storage unit 150 to the caption generation unit 140 together with the image 10. Note that, when the state information does not include position information of the target 20, the image extraction unit 135 may input nothing to the caption generation unit 140.

The caption generation unit 140 generates a caption describing the captured target 20 according to the state information, based on the state information and the plurality of words. The caption generation unit 140 may generate a caption based on newly input state information and a plurality of words by using the caption generation model that has learned a relationship among state information, one or a plurality of words representing features of the target 20 in the plant, and a caption describing the target 20 in the plant. The caption generation unit 140 may, for example, read out the caption generation model stored in the storage unit 150. The caption generation unit 140 may, as an example, generate a caption using both the new image 10 input from the image extraction unit 135 and the past image corresponding to the new image 10. The caption generation unit 140 transmits the generated caption as text data to the photographer terminal 41 via the communication network 50 based on the user ID of the photographer 31.

The storage unit 150 stores past images of the target 20 in the plant in association with position information. The storage unit 150 may also store the above-described fixed state information, the word extraction model, and the caption generation model. The storage unit 150 is an example of the model storage unit.

The report storage unit 155 receives the report from the photographer terminal 41 via the communication network 50 and registers the report in a memory. The report may be one that the photographer 31 has created by appropriately editing the caption using the photographer terminal 41. The report storage unit 155 is accessed via the communication network 50 from the administrator terminal 42, the worker terminal 43, and the like, and reports accumulated in the memory are read out.

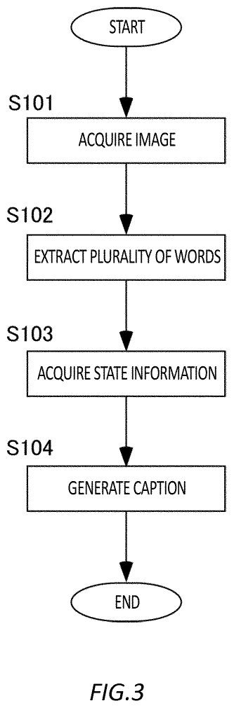

FIG. 3 is a flowchart illustrating a flow of the caption generation method according to the first embodiment. The flow is started, as an example, by the photographer 31 transmitting, via the communication network 50, to the caption generation apparatus 100, the image 10 obtained by capturing the target 20 in the plant by the photographer terminal 41.

The caption generation apparatus 100 acquires the image 10 captured in the plant (step S101). Specifically, the caption generation apparatus 100 receives, via the communication network 50 from the photographer terminal 41, the user ID of the photographer 31 together with the image 10 obtained by capturing the target 20 in the plant. Alternatively, the caption generation apparatus 100 may receive, via the communication network 50 from the photographer terminal 41, the user ID of the photographer 31 and position information of the photographer terminal 41 together with the image 10.

The caption generation apparatus 100 extracts the plurality of words representing features of the target 20 captured in the image 10 (step S102). Specifically, the caption generation apparatus 100 extracts a plurality of words representing features of the target 20 captured in the image 10 by using the above-described word extraction model.

The word extraction model learns a relationship between the image 10 and a plurality of image feature quantities and learns a relationship between the plurality of image feature quantities and a plurality of words, and, when a new image 10 is input, extracts a plurality of image feature quantities from the image 10 and outputs, from the plurality of image feature quantities, a plurality of words representing features of the target 20 captured in the image 10 as vector representations. The word extraction model may be, for example, the deep learning model having the neural network structure including the CNN (Convolution Neural Network) and the FC layer (Fully Connected Layer). The word extraction model may use Self-Attention or Multi-Head Self-Attention of a Transformer instead of the CNN.

The caption generation apparatus 100 acquires the state information indicating a state of the captured target 20 (step S103). Specifically, the caption generation apparatus 100 acquires the state information by analyzing the image 10. More specifically, the caption generation apparatus 100 extracts the target 20 from the image 10 by analyzing the image 10, and determines which instrument in the plant the target 20 corresponds to by collating features of the extracted target 20 with features of the plurality of targets 20 stored in the storage unit 150. For example, as a result of analyzing the image 10, the caption generation apparatus 100 may identify features such as the shape and model number of the target 20 captured in the image 10, collate the features with features of the plurality of targets 20 stored in the storage unit 150, and extract information of the instrument in the plant that is stored in association with the target 20 whose features match. For example, as a result of analyzing the image 10, the caption generation apparatus 100 may acquire identification information of the target 20 located on the surface of or around the target 20 captured in the image 10, collate the identification information with identification information of the plurality of targets 20 stored in the storage unit 150, and extract information of the instrument in the plant that is stored in association with the target 20 whose identification information matches. The caption generation apparatus 100 further accesses the distributed control system, and receives, from the distributed control system, state information regarding instrument corresponding to the target 20.

Additionally or alternatively, the caption generation apparatus 100 acquires the state information by receiving the above-described imaging information together with the image 10 from the photographer terminal 41. More specifically, the caption generation apparatus 100 determines which instrument in the plant the target 20 captured in the image 10 corresponds to by collating the imaging information received from the photographer terminal 41 with a plurality of pieces of imaging information stored in the storage unit 150. The caption generation apparatus 100 further accesses the distributed control system, and receives, from the distributed control system, state information regarding instrument corresponding to the target 20.

The caption generation apparatus 100 generates, based on the state information and the plurality of words, the caption describing the captured target 20 in accordance with the state information (step S104). Specifically, the caption generation apparatus 100 generates, as text data, using the caption generation model, the caption describing the captured target 20 in accordance with the state information, based on the state information indicating the state of the target 20 and the plurality of words. The caption generation apparatus 100 transmits text data of the generated caption to the photographer terminal 41 via the communication network 50, thereby ending the flow.

The caption generation model has learned a relationship between the vector representation of state information indicating a state of the target 20 and words representing features of the target 20, and a caption describing the target 20. When the vector representation of state information of the target 20 captured in the image 10 and vector representations of a plurality of words representing features of the target 20 are newly input, the caption generation model outputs text data of the caption describing the target 20 captured in the image 10 from the vector representation of the state information and the vector representations of the plurality of words. The caption generation model may be, for example, the deep learning model having a neural network structure including an RNN (Recurrent Neural Network). The caption generation model may use, instead of an RNN, the LSTM (Long Short-Term Memory), the Transformer, GPT-3™ (Generative Pre-trained Transformer-3), GPT™-2, GPT-3™-Clone, or the like. The caption generation model may use a large number of example sentences as training data, and may train the RNN or the like so as to increase, for each example sentence, a likelihood of outputting the example sentence. The caption generation model may extract words included in the example sentence, use vectors of the extracted words as training input data, use the example sentence as training output data, and learn so as to increase a probability of outputting the training output data for the training input data.

More specifically regarding steps S102 to S104, the caption generation apparatus 100 generates, using the word extraction model and the caption generation model, a caption describing the captured pipe 21 according to the state information, based on a plurality of words extracted from the image 10 and state information of the pipe 21 captured in the image 10.

For example, as illustrated in FIG. 1, when the image 10 shows a state in which an abnormality has occurred such that a crack has occurred in the pipe 21 and white gas is jetting out therefrom, the caption generation apparatus 100 that has acquired the image 10 may generate a caption such as “A crack has occurred in the pipe whose pipe ID is ○○ in Area A, and sulfuric acid gas is jetting out therefrom” according to the position information, the deterioration information, and the fluid information. For example, the caption generation apparatus 100 may generate a caption such as “There is a possibility that a crack has occurred in the pipe due to worsening rust of the pipe” according to the deterioration information. For example, the caption generation apparatus 100 may generate a caption such as “Since a crack has occurred in the pipe and gas is jetting out, please close the valve of the tank on the upstream side of the pipe” in accordance with the deterioration information and the equipment information. For example, the caption generation apparatus 100 may generate a caption such as “White smoke is coming out of the pipe for which one year has elapsed since start of use” in accordance with maintenance information of the pipe 21, which is an example of the deterioration information. For example, the caption generation apparatus 100 may generate a caption such as “The pressure in the pipe is ○○ kPa, and liquid of ○○○ is leaking from the joint and dripping” in accordance with fluid information including a measured value of pressure of fluid flowing inside the pipe 21. The caption generation apparatus 100 transmits the caption to the photographer terminal 41 via the communication network 50.

The photographer 31 checks the caption displayed on the photographer terminal 41, and transmits, from the photographer terminal 41 to the caption generation apparatus 100 via the communication network 50, a report using the caption. The photographer 31 may appropriately edit the caption to create the report. Upon receiving the report from the photographer terminal 41, the caption generation apparatus 100 causes the report to be stored in the report storage unit 155. The report stored in the report storage unit 155 of the caption generation apparatus 100 is viewed by, for example, the recovery worker 33 for the pipe 21, and the recovery worker 33 may seal the crack of the pipe 21 or adjust a valve of the tank 22 on the upstream side of the pipe 21. The report stored in the report storage unit 155 of the caption generation apparatus 100 is viewed by, for example, the administrator 32 of the pipe 21, and the administrator 32 may order the recovery worker 33 for the pipe 21 to perform recovery work or adjust a control parameter of instrument in which the pipe 21 is provided.

In steps S103 to S104, when the state information includes position information of the target 20, the caption generation apparatus 100 may extract, from the storage unit 150, one or a plurality of past images having position information common to the position information, and may generate a caption using both the image 10 and the one or the plurality of past images. For example, the caption generation apparatus 100 may identify a change in the target 20 captured in the image 10, such as the progress state of rust generated on a surface of the target 20, by comparing one or a plurality of past images and the image 10 in accordance with a date and time at which each image was captured. In this case, the caption generation apparatus 100 may generate the caption corresponding to the change and the state information, based on the state information, the change in the target 20 identified as a result of the comparison, and a plurality of words.

According to the caption generation apparatus 100 of the first embodiment described above, the caption describing the target 20 is generated from the image 10 of the target 20 captured in a plant, in accordance with state information indicating a state of the target 20. Accordingly, the caption generation apparatus 100 can generate a caption with higher accuracy, that is, can output an explanatory sentence that more accurately describes the state of the target 20 and the like, as compared with a case of generating a caption describing the target 20 from the image 10 capturing the target 20 without using the state information.

In the caption generation apparatus 100 according to the first embodiment, the word extraction unit 120 may be input with the state information acquired by the state information acquisition unit 130, and may assign, to each of a plurality of words to be extracted from the image 10, a likelihood corresponding to the state information. The word extraction unit 120 may be input with, for example, an image 10 capturing the target 20 and, as state information of the target 20 captured in the image 10, the degree of deterioration that is an index of a deterioration state corresponding to a rusting degree of the target 20 and the like. In this case, the word extraction unit 120 may assign a high likelihood to the word having high relevance to the deterioration state of the target 20, and may assign a low likelihood to the word having low relevance to the deterioration state of the target 20.

More specifically, the word extraction unit 120 may assign, to each of a plurality of words to be extracted from the image 10, a likelihood corresponding to the state information, by using the word extraction model. The word extraction model, for example, inputs pixel values of respective pixels of the image to respective input nodes of the input layer, and outputs a scalar value for each word from respective output nodes of the output layer. The scalar value may be the output value having a reference range of 0 to 1. The word vector in this case is the vector having, for each word, the above scalar value of 0 to 1. When the output value of the word is 0, it means that the image 10 does not represent the word, and when the output value of the word is 1, it means that the image 10 represents the word. The word extraction model is, for example, trained so as to output a value closer to 1 as the possibility that the image 10 represents the word is higher. The word extraction model is further, for example, repeatedly trained using, as input training data, a certain image 10 and state information acquired from the image 10 by the state information acquisition unit 130, and using, as output training data, a plurality of words extracted by decomposing a caption actually generated from the image 10 and the state information by the caption generation unit 140. In this case, the word extraction model outputs a value closer to 1 as the possibility that the image 10 represents the word is higher, and also outputs a value closer to 1 as the relevance between the state information and the word is higher. The word extraction unit 120, for example, treats the scalar value of each word output from the word extraction model as the likelihood for convenience, and assigns the likelihood to each word.

As one specific example, it is assumed that the image 10 acquired by the word extraction unit 120 shows the tank 22, the pipe 21 connected to the tank 22, the crack occurring in the pipe 21, gas generated from the crack, a valve attached to the pipe 21, other equipment not connected either directly or indirectly to the tank 22 and the pipe 21, and the wall around the tank 22 and the pipe 21. For example, in a case where the reference range of the output value for each word is 0 to 1, the word extraction model may, based on the deterioration degree, set the output value for the word “tank” to 0.9, set the output value for the word “pipe” to 0.9, set the output value for the word “crack” to 0.8, set the output value for the word “gas” to 0.5, set the output value for the word “valve” to 0.4, and set the output value for the word indicating other equipment and the word “wall” to 0.2. In this case, the word extraction unit 120 may, using the output value from the word extraction model, treat, for example, the probability of the word “crack” as 80%.

In this case, the caption generation unit 140 may generate a caption, based on the state information and the plurality of words, using a word the likelihood of which is higher among the plurality of words with higher priority. Thus, the caption generation apparatus 100 can generate the caption with even higher accuracy.

The caption generation unit 140 may generate a plurality of captions, and in this case, the caption generation unit 140 may further assign, to the generated captions, a priority corresponding to the likelihood of at least one word, among the plurality of words, used for caption generation. The priority may be the average value, the total value, or an integrated value of the likelihoods of the plurality of words. The caption generation unit 140 may transmit, among the plurality of generated captions, the caption having the highest priority to the photographer terminal 41. Alternatively, the caption generation unit 140 may transmit the plurality of generated captions to the photographer terminal 41 in a state in which priority is assigned to each of the plurality of generated captions. In this case, the photographer 31 can determine appropriateness of the plurality of captions while referring to the priorities.

As an example in a case of generating a plurality of captions, the caption generation unit 140 may generate a second caption after applying a negative weight to a word used when generating a first caption among the plurality of words extracted by the word extraction unit 120, thereby preventing the word used in the first caption from being included in the second caption. As another example in a case of generating a plurality of captions, the caption generation unit 140 may, after assigning arbitrary priorities to the plurality of words extracted by the word extraction unit 120, reduce the priority of the word by a predetermined amount each time the word is used in caption generation, thereby using the plurality of words extracted by the word extraction unit 120 as a whole.

The caption generation unit 140 may also output a caption including an instruction to recapture an image of the captured target 20 when the likelihood of a combination of the plurality of words used for caption generation is lower than a predetermined threshold. For example, the caption generation unit 140 may output a caption including an instruction to recapture an image of the captured target 20 when the average value, the total value, an integrated value, or the like of the likelihoods of the plurality of words used for caption generation is less than a predetermined threshold stored in the storage unit 150.

In the caption generation apparatus 100 according to the first embodiment, the storage unit 150 may store, as example sentences, a plurality of sentences included in at least any of an accident case collection in a plant, an accident response manual, or a maintenance history. In this case, the caption generation unit 140 may extract at least one of the example sentences by searching, from among the plurality of example sentences stored in the storage unit 150, using at least any of the plurality of words extracted by the word extraction unit 120.

The caption generation unit 140 may generate the caption based on state information acquired by the state information acquisition unit 130, the plurality of words, and the extracted example sentence. Specifically, the caption generation unit 140 may search, from among the plurality of example sentences stored in the storage unit 150, for the example sentence in which at least any of the plurality of words is used, and may generate a caption while referring to the extracted example sentence.

In this case, the caption generation unit 140 may generate a plurality of captions and may assign the degree of similarity to the extracted example sentence. Specifically, the caption generation unit 140 may generate a plurality of captions based on the state information and the plurality of words, and may search, from among the plurality of example sentences stored in the storage unit 150, for the example sentence in which at least any of the plurality of words is used, and may assign, to each of the plurality of captions, a degree of similarity to the extracted example sentence. For example, the caption generation unit 140 may convert each of the plurality of captions and the extracted example sentence into the feature vector indicating a combination of a plurality of words included in each, and may calculate an inner product between the feature vectors to obtain the degree of similarity. The caption generation unit 140 may transmit, to the photographer terminal 41, the caption having the highest degree of similarity among the generated plurality of captions. Alternatively, the caption generation unit 140 may transmit, to the photographer terminal 41, the plurality of generated captions in a state in which the degree of similarity is assigned to each of the plurality of generated captions. In this case, the photographer 31 can determine appropriateness of the plurality of captions while referring to the degree of similarity.

The caption generated by the caption generation unit 140 while referring to the extracted example sentence may include, in addition to the caption describing the target 20 in the plant, a plurality of action options regarding actions to be taken by a user or an instruction to the user. As a result of generating a caption with reference to an example sentence, the caption generation apparatus 100 can present to a user action options or instructions including an abnormality handling method that cannot be directly deciphered from the image 10.

The caption generated by the caption generation apparatus 100 according to the first embodiment may include, in addition to the caption describing the target 20 in the plant, at least any of an instruction to capture an image of the captured target 20 from a different angle or with a different angle of view, or an instruction to capture an image of another target 20 related to the captured target 20.

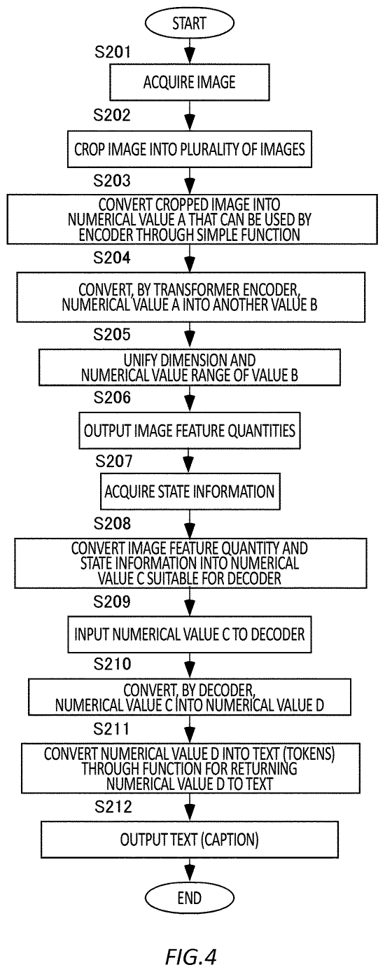

FIG. 4 is a flowchart illustrating an example of the detailed flow of the caption generation method according to the first embodiment. The operation flow shown in the flowchart of FIG. 4 may be the specific example of the caption generation method according to the first embodiment described with reference to FIG. 3. As an example, the caption generation apparatus 100 according to the first embodiment described above may generate a caption describing the target 20 from the image 10 obtained by capturing the target 20, in accordance with the operation flow shown in the flowchart of FIG. 4.

The flow of FIG. 4 is started, as an example, when the photographer 31 transmits, via the communication network 50, the image 10 obtained by capturing the target 20 in the plant by the photographer terminal 41 to the caption generation apparatus 100.

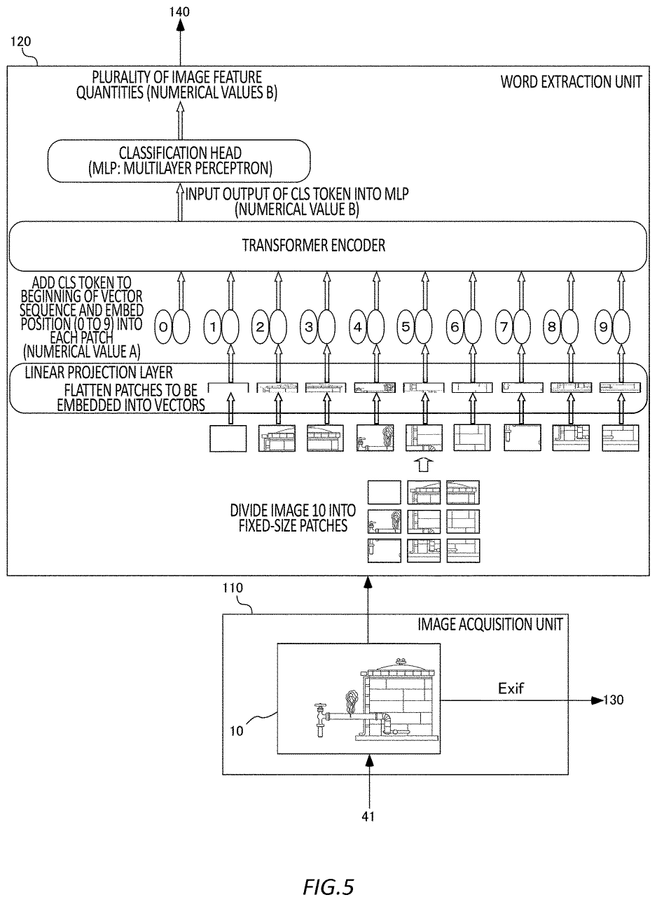

The caption generation apparatus 100 acquires the image 10 captured in the plant (step S201). In step S201, as shown in FIG. 5 specifically describing a part of the flow of FIG. 4, the image acquisition unit 110 receives, via the communication network 50, the image 10 obtained by capturing the target 20 in the plant from the photographer terminal 41, and extracts Exif information from the image 10. The Exif information may include the user ID of the photographer 31. The image acquisition unit 110 may output the image 10 to the word extraction unit 120, and may output Exif information together with the image 10 to the state information acquisition unit 130.

The caption generation apparatus 100 crops the image 10 into a plurality of images (step S202). For example, the caption generation apparatus 100 creates a new image obtained by discarding the peripheral region in the image 10 that does not include the target 20, and divides the new image into fixed-size patches. In step S202, as illustrated in FIG. 5, the word extraction unit 120 may create a new image obtained by discarding the peripheral region from the image 10 that does not include the pipe 21 and the tank 22, and may divide the new image into three parts vertically and three parts horizontally to form nine patches. Alternatively, the word extraction unit 120 may create, from the image 10, a new image obtained by discarding the peripheral region that does not include the pipe 21 as one fixed-size patch, and may create the new image obtained by discarding the peripheral region that does not include the tank 22 as another fixed-size patch. The learning model of the word extraction unit 120 illustrated in FIG. 5 may also be referred to as a Vision Transformer, and may be an example of the word extraction model described above.

The caption generation apparatus 100 converts the cropped image into a numerical value A that can be used by the encoder through a simple function, for example, a LINEAR function (step S203). In step S203, as illustrated in FIG. 5, the word extraction unit 120 may input nine patches into the linear projection layer, flatten each of the nine patches, and embed each of the nine patches into a vector (linearly) (or may convert each of the nine patches into a one-dimensional array). The word extraction unit 120 may further add the CLS token to the beginning of a sequence of vectors output from the linear projection layer (Extra learnable [class] embedding), and may embed a position into each patch (each vector) (Position Embedding) to obtain the numerical value A. That is, the word extraction unit 120 may convert nine patches divided from the image 10 into the sequence of 10-dimensional vectors that can be used by the encoder.

The caption generation apparatus 100 converts, by the transformer encoder, the numerical value A into another value B (step S204), and unifies the dimension and numerical value range of the value B (step S205). In steps S204 to S205, as illustrated in FIG. 5, the word extraction unit 120 may input the sequence of 10-dimensional vectors to the transformer encoder, the transformer encoder may convert the sequence into another sequence of 10-dimensional vectors, and, for example, may unify the dimension and numerical value range through a softmax function and output the result as an output of the CLS token. The transformer encoder may include a plurality of components such as the above-described Self-Attention. The output of the CLS token may be obtained by aggregating, by Self-Attention, feature quantities necessary for classification from the entire image.

The caption generation apparatus 100 outputs the image feature quantity (step S206). In step S206, as illustrated in FIG. 5, the word extraction unit 120 may input the output of the CLS token to the classification head (MLP: multilayer perceptron) and output a plurality of image feature quantities from the classification head. The classification head may output the plurality of image feature quantities after compressing the plurality of image feature quantities. As illustrated in FIG. 5, the word extraction unit 120 may output a plurality of image feature quantities to the caption generation unit 140, and, as described with reference to FIGS. 1 to 3, may extract, from the plurality of image feature quantities, word vectors of a plurality of words representing features of the target 20 captured in the image 10 and output the word vectors to the caption generation unit 140.

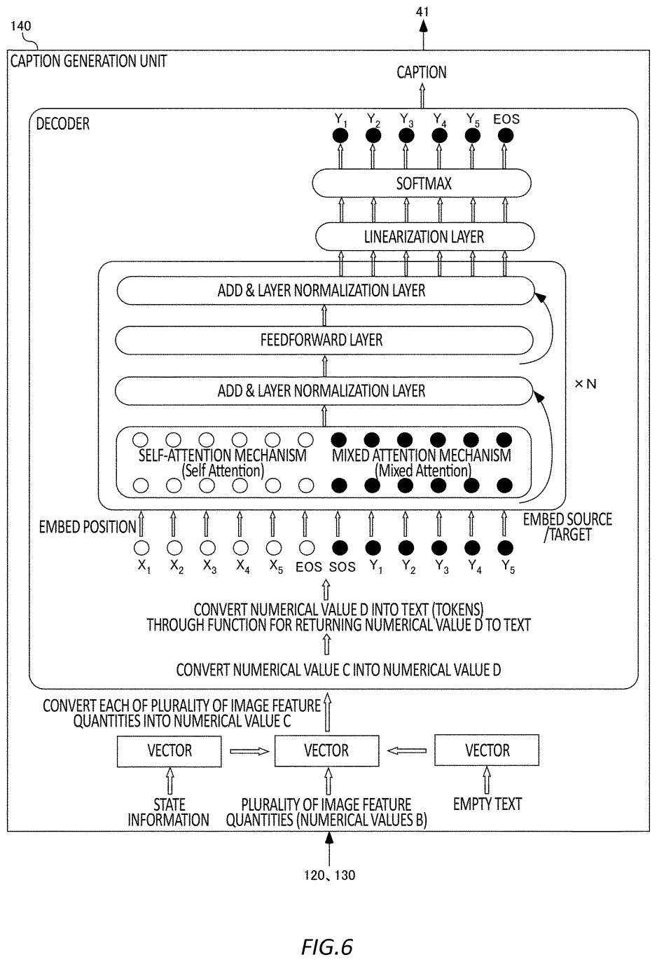

The caption generation apparatus 100 acquires state information (step S207), converts the image feature quantities and the state information into numerical values C suitable for the decoder (step S208), and inputs the numerical values C to the decoder (step S209). In steps S207 to S209, as illustrated in FIG. 6 that specifically describes a part of the flow of FIG. 4, the caption generation unit 140 vectorizes, for example through a LINEAR function, state information input from the state information acquisition unit 130, and vectorizes empty text, and vectorizes these vectors together with the plurality of image feature quantities input from the word extraction unit 120. Thus, the caption generation unit 140 converts each of the plurality of image feature quantities into a numerical value C. The caption generation unit 140 further inputs the numerical value C to the decoder. The learning model of the decoder is the model using adjustment on a layer-by-layer basis, may also be referred to as GPT™-2, and may be an example of the caption generation model described above.

The caption generation apparatus 100 converts, by the decoder, the numerical value C into a numerical value D (step S210), and converts the numerical value D into text (tokens) through the function for returning the numerical value D to text (step S211). In steps S210 to S211, as illustrated in FIG. 6, the decoder in the caption generation unit 140 may convert the numerical value C into the numerical value D. The decoder may weight each numerical value D based on the vectorized state information. The decoder may compress the numerical value D. The decoder may convert the numerical value D into text (tokens) through the softmax function.

The caption generation apparatus 100 outputs text (the caption) (step S212), and the flow ends. In step S212, as illustrated in FIG. 6, the decoder may, for example, use a continuous text sequence of X₁ to X₅ as an input (source tokens), use, as target tokens, a continuous text sequence of Y₁ to Y₅ that is the sequence identical to the sequence and shifted right by one token, concatenate the source tokens and the target tokens, and perform processing with adjustment for each layer. In the source tokens and the target tokens, respective resettable positions of the source tokens and the target tokens may be embedded together with the respective corresponding tokens. The positions of the source tokens may start from zero, and for the target tokens, instead of incrementing the positions at the end of the source sentence, the positions may be reset again from zero.

The decoder model illustrated in FIG. 6 includes, as an example, a stack of N layers in which the attention mechanisms including the self-attention mechanism (Self-Attention) and the mixed attention mechanism (Mixed Attention), the add & layer normalization layer, the feedforward (FNN) layer, and the add & layer normalization layer are arranged in this order. The decoder may input the output processed by the N layers into the linearization layer, pass the output from the linearization layer through a softmax function, and output a caption composed of the continuous text sequence of Y₁ to Y₅. The caption generation unit 140 may transmit text data of the generated caption to the photographer terminal 41 via the communication network 50.

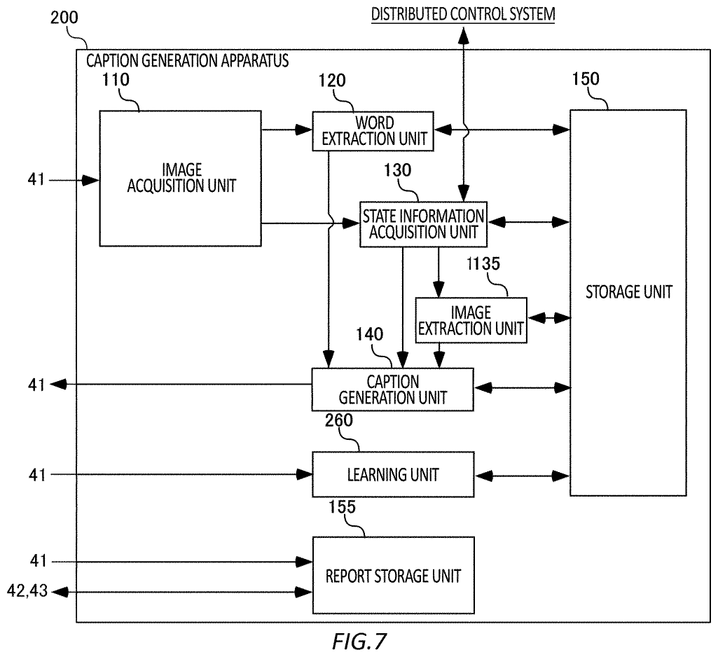

FIG. 7 is a block diagram illustrating the caption generation apparatus 200 according to a second embodiment. The caption generation apparatus 200 according to the second embodiment includes the learning unit 260 in addition to the configuration included in the caption generation apparatus 100 according to the first embodiment. Other configurations included in the caption generation apparatus 200 according to the second embodiment are similar to those of the caption generation apparatus 100 according to the first embodiment, and redundant description is omitted by using the reference numerals of the respective configurations included in the caption generation apparatus 100.

The learning unit 260 learns the above-described word extraction model and caption generation model by using a result of the user determining appropriateness of a caption generated by the caption generation unit 140. In addition to or instead of this, the learning unit 260 may learn the above-described word extraction model and caption generation model by using the user correction input with respect to a caption generated by the caption generation unit 140. The learning unit 260 receives, from the photographer terminal 41 via the communication network 50, the above-described determination result and the correction input by the user.

The learning unit 260 updates parameters of the model so as to reduce an error between an output of the model when each sample in training data including the above-described determination result is input to the model, and the label. For example, when learning the word extraction model using the multilayer neural network including a CNN or the like, the learning unit 260 adjusts, by a method such as backpropagation, a weight between each neuron of the neural network and a bias of each neuron, using the error between an output value output by the neural network in response to an input of each sample and a label.

In this manner, in the caption generation apparatus 200 according to the second embodiment, information as to whether or not the generated caption was actually used by the user is fed back, and the word extraction model and the caption generation model are learned using the feedback content. The caption generation apparatus 200 may determine that the generated caption was actually used, for example, when the caption generation apparatus 200 receives, from the administrator terminal 42, the determination result that the administrator 32 has determined, as a result of viewing the caption, that there is no problem. The caption generation apparatus 200 may also determine that the generated caption was actually used, for example, when the caption generation unit 140 performs a search for example sentences using the generated caption, or when the caption generation unit 140 uses the generated caption for a report for the administrator 32. The caption generation apparatus 200 according to such the second embodiment also achieves effects similar to those of the caption generation apparatus 100 according to the first embodiment. In accordance with the caption generation apparatus 200 according to the second embodiment, the caption with even higher accuracy can be generated.

Various embodiments of the present invention may be described with reference to flowcharts and block diagrams whose blocks may represent (1) steps of processes in which operations are performed or (2) sections of apparatuses responsible for performing operations. Certain stages and sections may be implemented by a dedicated circuit, a programmable circuit supplied together with computer-readable instructions stored on computer-readable media, and/or processors supplied together with computer-readable instructions stored on computer-readable media. The dedicated circuit may include digital and/or analog hardware circuits, and may include integrated circuits (IC) and/or discrete circuits. The programmable circuit may include a reconfigurable hardware circuit including logical AND, logical OR, logical XOR, logical NAND, logical NOR, and other logical operations, a memory element or the like such as a flip-flop, a register, a field programmable gate array (FPGA) and a programmable logic array (PLA), or the like.

A computer-readable medium may include any tangible device that can store instructions to be executed by a suitable device, and as a result, the computer-readable medium having instructions stored thereon includes a product including instructions that can be executed in order to create means for executing operations designated in the flowcharts or block diagrams. Examples of the computer-readable medium may include an electronic storage medium, a magnetic storage medium, an optical storage medium, an electromagnetic storage medium, a semiconductor storage medium, and the like. More specific examples of the computer-readable medium may include a floppy™ disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a Blu-ray™ disk, a memory stick, an integrated circuit card, and the like.

The computer-readable instruction may include: an assembler instruction, an instruction-set-architecture (ISA) instruction; a machine instruction; a machine dependent instruction; a microcode; a firmware instruction; state-setting data; or either a source code or an object code described in any combination of one or more programming languages, including an object oriented programming language such as Smalltalk™, JAVA™, C++, or the like, and a conventional procedural programming language such as a “C” programming language or a similar programming language.

The computer-readable instructions may be provided for a processor or programmable circuit of a general-purpose computer, special-purpose computer, or other programmable data processing apparatuses such as a computer locally or via a wide area network (WAN) such as a local area network (LAN), the Internet, or the like, and execute the computer-readable instructions in order to create means for executing the operations designated in flowcharts or block diagrams. Examples of the processor include a computer processor, a processing unit, a microprocessor, a digital signal processor, a controller, a microcontroller, and the like.

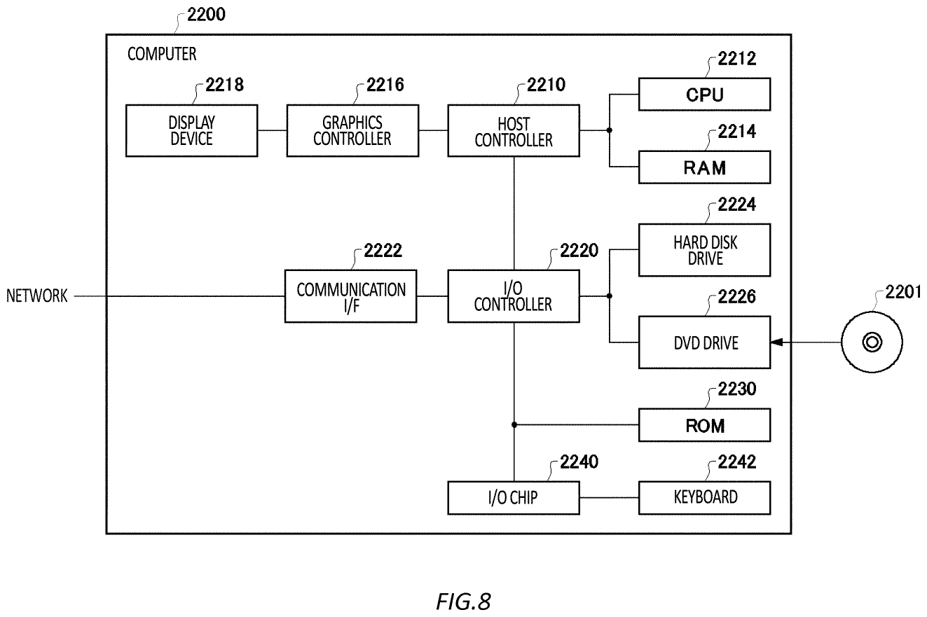

FIG. 8 illustrates an example of a computer 2200 in which a plurality of aspects of the present invention may be embodied wholly or in part. A program installed in the computer 2200 can cause the computer 2200 to function as an operation associated with the apparatuses according to the embodiments of the present invention or as one or more sections of the apparatuses, or can cause the operation or the one or more sections to be executed, and/or can cause the computer 2200 to execute a process according to the embodiments of the present invention or a step of the process. Such programs may be executed by a CPU 2212 to cause the computer 2200 to perform specific operations associated with some or all of the blocks in the flowcharts and block diagrams described in the present specification.

The computer 2200 according to the present embodiment includes the CPU 2212, a RAM 2214, a graphics controller 2216, and a display device 2218, which are interconnected by a host controller 2210. The computer 2200 also includes input/output units such as a communication interface 2222, a hard disk drive 2224, a DVD-ROM drive 2226, and an IC card drive, which are connected to the host controller 2210 via an input/output controller 2220. The computer also includes legacy input/output units such as a ROM 2230 and a keyboard 2242, which are connected to the input/output controller 2220 via an input/output chip 2240.

The CPU 2212 operates according to programs stored in the ROM 2230 and the RAM 2214, thereby controlling each unit. The graphics controller 2216 acquires image data generated by the CPU 2212 in a frame buffer or the like provided in the RAM 2214 or in itself, such that the image data is displayed on the display device 2218.

The communication interface 2222 communicates with other electronic devices via a network. The hard disk drive 2224 stores programs and data used by the CPU 2212 in the computer 2200. The DVD-ROM drive 2226 reads a program or data from a DVD-ROM 2201 and provides the program or data to the hard disk drive 2224 via the RAM 2214. The IC card drive reads the programs and the data from the IC card, and/or writes the programs and the data to the IC card.

The ROM 2230 stores therein boot programs and the like executed by the computer 2200 at the time of activation, and/or programs that depend on the hardware of the computer 2200. The input/output chip 2240 may also connect various input/output units to the input/output controller 2220 via a parallel port, a serial port, a keyboard port, a mouse port, or the like.

Programs are provided by a computer-readable medium such as the DVD-ROM 2201 or the IC card. The programs are read from the computer-readable medium, are installed in the hard disk drive 2224, the RAM 2214, or the ROM 2230 which is also an example of the computer-readable medium, and are executed by the CPU 2212. The information processing described in these programs is read by the computer 2200, and provides cooperation between the programs and the various types of hardware resources. The apparatus or method may be configured by implementing operations or processing of information according to use of the computer 2200.

For example, in a case where communication is performed between the computer 2200 and an external device, the CPU 2212 may execute a communication program loaded in the RAM 2214 and instruct the communication interface 2222 to perform communication processing based on processing described in the communication program. Under the control of the CPU 2212, the communication interface 2222 reads transmission data stored in a transmission buffer processing region provided in a recording medium such as the RAM 2214, the hard disk drive 2224, the DVD-ROM 2201, or the IC card, transmits the read transmission data to the network, or writes reception data received from the network in a reception buffer processing region or the like provided on the recording medium.

In addition, the CPU 2212 may cause the RAM 2214 to read all or a necessary part of a file or database stored in an external recording medium such as the hard disk drive 2224, the DVD-ROM drive 2226 (DVD-ROM 2201), the IC card, or the like, and may execute various types of processing on data on the RAM 2214. Then, the CPU 2212 writes the processed data back in the external recording medium.

Various types of information such as various types of programs, data, tables, and databases may be stored in a recording medium and subjected to information processing. The CPU 2212 may execute, on the data read from the RAM 2214, various types of processing including various types of operations, information processing, conditional judgement, conditional branching, unconditional branching, information retrieval/replacement, or the like described throughout the present disclosure and specified by instruction sequences of the programs, and write the results back to the RAM 2214. In addition, the CPU 2212 may retrieve information in a file, a database, or the like in the recording medium. For example, when a plurality of entries, each having an attribute value of a first attribute associated with an attribute value of a second attribute, are stored in the recording medium, the CPU 2212 may retrieve, out of the plurality of entries, an entry with the attribute value of the first attribute specified that meets a condition, read the attribute value of the second attribute stored in said entry, thereby acquiring the attribute value of the second attribute associated with the first attribute meeting a predetermined condition.

The programs or software modules described above may be stored in a computer-readable medium on or near the computer 2200. In addition, a recording medium such as a hard disk or a RAM provided in a server system connected to a dedicated communication network or the Internet can be used as a computer-readable medium, thereby providing a program to the computer 2200 via the network.

While the present invention has been described by way of the embodiments, the technical scope of the present invention is not limited to the above-described embodiments. It is apparent to persons skilled in the art that various alterations or improvements can be added to the above-described embodiments. It is also apparent from the described scope of the claims that the embodiments added with such alterations or improvements can be included in the technical scope of the present invention.

For example, the control system may be a computer housed in a single enclosure. That is, the controller may be realized by executing the program on the processor of the computer, and each input and output device may be implemented as an input/output device of the computer. In addition, the controller may also be implemented as a virtual machine executed by one or more processors. In such a configuration, the control system does not have a network that is a general-purpose or dedicated network, and the controller and the input and output device can be connected by a chipset, such as a memory controller hub and an input/output controller hub, which connects the processor and the input/output device to each other.

Note that the operations, procedures, steps, stages, or the like of each process performed by a device, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams for convenience, it does not necessarily mean that the process must be performed in this order.

### EXPLANATION OF REFERENCES

5 caption generation system
10 image
20 target
21 pipe
22 tank
31 photographer
32 administrator
33 recovery worker
41 photographer terminal
42 administrator terminal
43 worker terminal
100 caption generation apparatus
110 image acquisition unit
120 word extraction unit
130 state information acquisition unit
135 image extraction unit
140 caption generation unit
150 storage unit
155 report storage unit
200 caption generation apparatus
260 learning unit
2200 computer
2201 DVD-ROM
2210 host controller
2212 CPU
2214 RAM
2216 graphics controller
2218 display device
2220 input/output controller
2222 communication interface
2224 hard disk drive
2226 DVD-ROM drive
2230 ROM
2240 input/output chip
2242 keyboard.

1. A caption generation apparatus comprising:
an image acquisition unit that acquires an image captured in a plant;
a word extraction unit that extracts a plurality of words representing features of a target captured in the image;
a state information acquisition unit that acquires state information indicating a state of the captured target; and
a caption generation unit that generates, based on the state information and the plurality of words, a caption describing the captured target in accordance with the state information.

2. The caption generation apparatus according to claim 1, wherein the state information includes at least any of position information of the target, deterioration information indicating a deterioration state of the target, fluid information indicating a component or a state of a fluid flowing inside a pipe that is the target, or equipment information related to equipment located on an upstream side or a downstream side of the pipe that is the target.

3. The caption generation apparatus according to claim 2, wherein the state information acquisition unit acquires the state information by analyzing the image.

4. The caption generation apparatus according to claim 1, wherein
the state information includes position information of the target,
the caption generation apparatus further comprises:
a storage unit that stores a past image of a target in the plant and position information, in association with each other; and
an image extraction unit that extracts, in response to acquisition of new state information of a new image, the past image having position information common to the position information included in the new state information, and
the caption generation unit generates the caption using both the new image and the past image corresponding to the new image.

5. The caption generation apparatus according to claim 1, wherein
the word extraction unit assigns, to each of the plurality of words extracted from the image, a likelihood according to the state information, and
the caption generation unit generates the caption by using, based on the state information and the plurality of words, a word the likelihood of which is higher among the plurality of words with higher priority.

6. The caption generation apparatus according to claim 5, wherein the caption generation unit assigns, to the generated caption, a priority according to the likelihood of at least one word, among the plurality of words, used for caption generation.

7. The caption generation apparatus according to claim 5, wherein, when the likelihood of a combination of a plurality of words used for caption generation is lower than a predetermined threshold, the caption generation unit outputs the caption including an instruction to recapture an image of the captured target.

8. The caption generation apparatus according to claim 1, further comprising:
a storage unit that stores a plurality of sentences as example sentences, the sentences being included in at least any of an accident case collection in the plant, an accident response manual, or a maintenance history, wherein
the caption generation unit extracts at least one of the example sentences by searching, from among the plurality of example sentences stored in the storage unit, using at least any of the extracted plurality of words, and generates the caption based on the state information, the plurality of words, or the extracted example sentence.

9. The caption generation apparatus according to claim 8, wherein the caption generation unit generates a plurality of captions and assigns a degree of similarity to the extracted example sentence.

10. The caption generation apparatus according to claim 8, wherein the caption includes a plurality of action options regarding actions to be taken by a user, or an instruction to the user.

11. The caption generation apparatus according to claim 1, wherein the caption includes at least any of an instruction to capture an image of the captured target at a different angle or with a different angle of view, or an instruction to capture an image of another target related to the captured target.

12. The caption generation apparatus according to claim 1, further comprising:
a model storage unit that stores a caption generation model trained to learn a relationship among the state information, one or a plurality of words representing features of a target in the plant, and a caption describing a target in the plant, wherein
the caption generation unit generates the caption based on newly input state information and the plurality of words by using the caption generation model.

13. The caption generation apparatus according to claim 1, further comprising:
a learning unit that trains a word extraction model that extracts the plurality of words from the image, and a caption generation model that generates the caption from the state information and the plurality of words, by using a result of a user's determination as to whether or not the generated caption is appropriate, wherein
the caption generation unit generates the caption based on newly input state information and the plurality of words by using the caption generation model.

14. The caption generation apparatus according to claim 1, further comprising:
a learning unit that trains a word extraction model that extracts the plurality of words from the image, and a caption generation model that generates the caption from the state information and the plurality of words, by using a user's correction input for the generated caption, wherein
the caption generation unit generates the caption based on newly input state information and the plurality of words by using the caption generation model.

15. A caption generation method comprising:
acquiring an image captured in a plant; extracting a plurality of words representing features of a target captured in the image;
acquiring state information indicating a state of the captured target; and
generating a caption describing the captured target according to the state information based on the state information and the plurality of words.

16. A non-transitory computer-readable medium storing a program for causing a computer to execute:
acquiring an image captured in a plant;
extracting a plurality of words representing features of a target captured in the image;
acquiring state information indicating a state of the captured target; and
generating a caption describing the captured target according to the state information based on the state information and the plurality of words.
